(19) United States
(12) Patent Application Publication
(10) Pub. No.: US 2016/0059162 A1
(43) Pub. Date: Mar. 3, 2016

(54) SCREEN HAVING FRAME MEMBERS WITH ANGLED SURFACE(S)

(71) Applicant: M-I DRILLING FLUIDS UK LTD., Westhill (GB)

(72) Inventors: Andrew Ralph, Edinburgh (GB); Graham Robertson, Florence, KY (US)

(73) Assignee: M-I DRILLING FLUIDS UK LTD., Westhill (GB)

(21) Appl. No.: 14/888,381

(22) PCT Filed: Apr. 30, 2014
(86) PCT No.: PCT/US2014/036273

§ 371 Date: Oct. 30, 2015

Related U.S. Application Data
(60) Provisional application No. 61/817,482, filed on Apr. 30, 2013.

(51) Int. Cl. B01D 33/03

(52) U.S. Cl. CPC B01D 33/0361

(57) ABSTRACT

This disclosure is generally drawn to systems, devices, apparatus, and/or methods related to screening and/or filtration of fluid. Specifically, the disclosed systems, devices, apparatus, and/or methods relate to screens having frame members with angled surface(s) for drilling environments. In some examples, an apparatus may include a frame and mesh. The frame may include opposing ends, opposing sides, and a plurality of frame members coupled to and extending between the opposing ends. A portion or section of the plurality of frame members may extend through and be coupled to the mesh. The plurality of frame members have at least one surface angled downward relative to the mesh.

### BACKGROUND

The present disclosure contemplates that many applications require fluids be screened to remove solids (such as foreign objects, rocks, and particulates). Some examples include water treatment applications, hazardous material handling applications, and drilling applications. For example, in oilfield environments, fluid used in oilfield activities must be filtered via a screening process.

Failure to keep solids out of the drilling fluid could mean diminished rate of penetration, equipment damage, increased non-productive time, and higher costs. Further, efficient screening reduces the time required to filter the fluid. Increased fluid capacity of screens allows the filtering process to complete quickly.

The present disclosure further contemplates that one mechanism for separating the contaminants and/or undesirable objects from drilling fluid are screens held in place by the screen bed of a vibratory shaker. The screens may filter contaminants and/or undesirable objects from the drilling fluid as the vibratory shaker operates.

### BRIEF DESCRIPTION OF THE DRAWINGS

The foregoing and other features of the present disclosure will become more fully apparent from the following description, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

In the drawings:

FIG. 1 depicts a front view of an example screen having frame members with angled surface(s);

FIG. 2 depicts a perspective view of another example screen having frame members with angled surface(s);

FIG. 3 depicts a plan view of yet another example screen having frame members with angled surface(s);

FIG. 4 depicts a partial side cross-sectional view of another example screen having frame members with angled surface(s);

FIG. 5 depicts a side cross-sectional view of another example screen having frame members with angled surface(s); and

FIGS. 6-9 depict example cross-sectional views of example screens having frame members with angled surface(s);

all arranged in accordance with at least some of the embodiments disclosed in the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is generally drawn to systems, devices, apparatus, and/or methods related to screening and/or filtration. Specifically, the disclosed systems, devices, apparatus, and/or methods relate to screens having frame members with angled surface(s) for drilling environments.

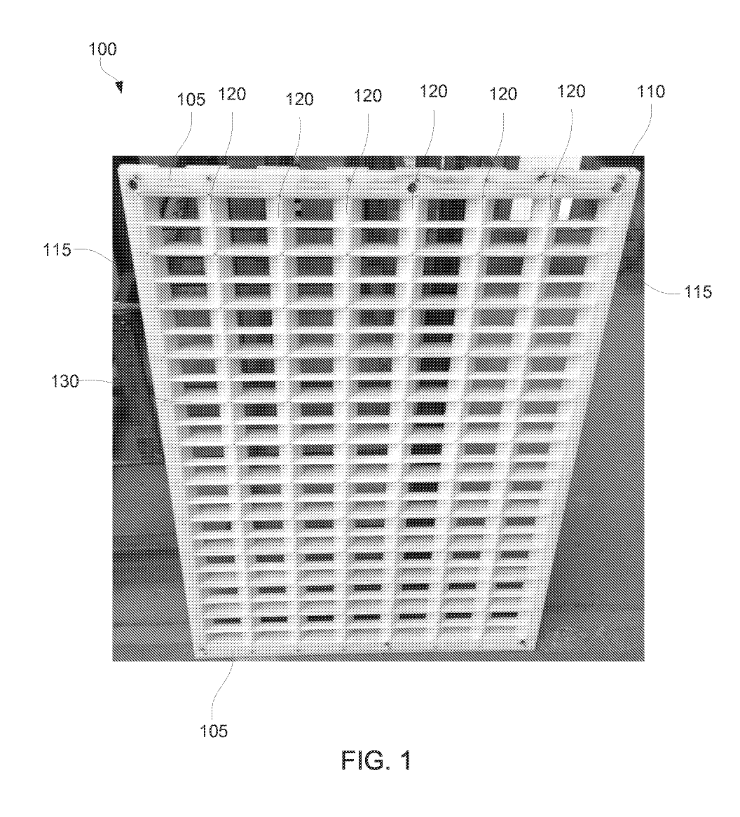

FIG. 1 depicts a front view of an example screen 100 having frame members 120 angled relative to mesh on the top surface of the screen 100, in accordance with at least one embodiment of the present disclosure. Example screen 100 may include a frame 110, frame member(s) 120, cross-members 130, and mesh. The frame 110 may include two opposing end members 105 which may be substantially parallel to each other. The frame 110 may also include two opposing side members 115 that are substantially parallel to each other and substantially perpendicular to the two opposing end members 105.

The frame members 120 may be coupled to and may extend between both end members 105. The frame members 120 may be substantially parallel to each other and substantially parallel to the side members 115. In some examples, the frame members 120 may be spaced apart from one another such that the frame members 120 are equidistant relative to each other.

Some example frame members 120 may have one or more surfaces that may be angled downward relative to a plane formed by the mesh on the frame 110 such that the frame members 120 appear slanted or tilted when viewed from above and/or below the screen 100. Some example frame members 120 may be angled and/or tilted about an axis extending the length of each frame member 120. In some examples, the surface(s) of the frame members 120 may be angled in a range of about 10 degrees to about 80 degrees (or about 100 degrees to about 170 degrees) relative to the mesh on the top surface plane of the frame 110. In some examples, surface(s) of the frame members 120 may be angled approximately 45 degrees relative to the mesh. From the perspective of the top surface (or inlet) of the screen 100, the frame members 120 may appear to diverge. In some examples, from the perspective of the bottom surface (or outlet) of the screen 100, the frame members 120 may appear to converge. In this manner, fluid passing through the screen 100 may contact the angled surface(s) of the frame members 120 and may be deflected, diverted, and/or directed through the screen 100.

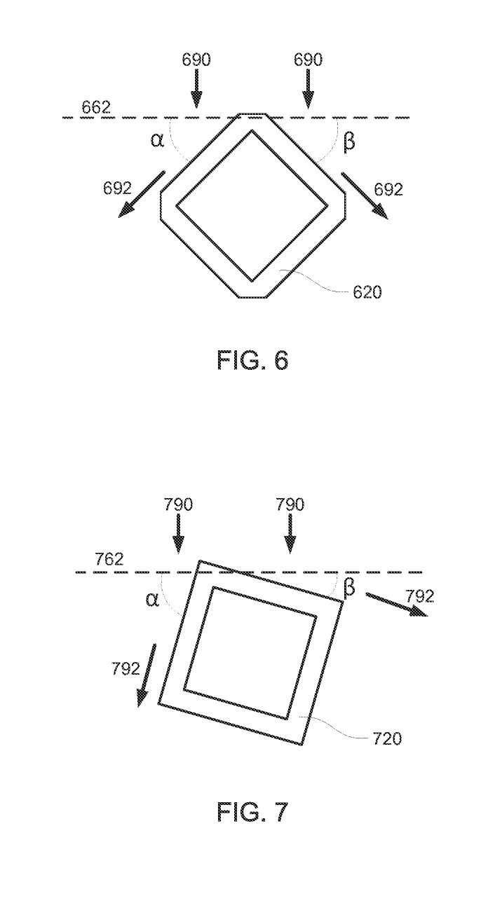

The frame members 120 may have surface(s) that extend the length of each frame member 120 (i.e. from one end of frame member 120 coupled to the end member 105 to the other end of frame member 120 coupled to the opposing end member 105). Each frame member's 120 cross section (as viewed from a side member 115 of the frame 110) may be any polygonal shape, including a triangular shape, a quadrilateral shape, a parallelogram shape, a square shape, a rectangular shape, and/or a rhombus shape, for example. Several example cross-section shapes are depicted in FIGS. 6-9. Some example frame members 120 may be frame members 120 having a substantially diamond shaped cross section. In some examples, a substantially diamond shaped cross section may include an equilateral quadrilateral where all sides are the same length. In some examples, the substantially diamond shaped cross section may have opposite sides that are parallel and opposite angles that are equal. For example, a frame member 120 with a diamond shaped cross section may include interior angles of about 45 degrees on two parallel opposing sides and about 135 degrees on two other opposing sides. In some examples, a frame member 120 may have a square shaped cross section in which all interior angles are about 90 degrees.

In some examples, a portion of the frame members 120 may extend above, beyond, or through the mesh of the screen 100. In this manner, a mesh cloth may be substantially coplanar with the top surface of the screen 100. The portion of the frame members 120 that extend through the mesh may be coupled to the mesh.

In some examples, the frame members 120 may be hollow, where the surfaces of the each frame member 120 form a void therein extending the length of the frame member 120. In some examples, the frame members 120 may be solid such that no void is created between the surfaces of the frame member 120. In some examples, the frame members 120 may be partially hollow and partially solid.

Some example frame members 120 may include reinforcement material therein. Some example reinforcement materials may include metal (e.g., carbon steel, stainless steel roll formed, aluminum extrusion) and/or composite materials (e.g., glass filled polypropylene, carbon fiber pultrusion). In some examples, the frame members 120 may include molding a composite material around the reinforcement material(s). In such examples, the composite material surrounding the reinforcement material(s) may be the surface(s) angled downward relative to the mesh.

In some examples, the frame members 120 may allow for improved manufacturability (e.g., simpler manufacturing techniques), increased screen stiffness, and greater open areas for material to pass through the screen 100.

The cross-members 130 may be coupled to and may extend between the side members 115 of the frame 110 (i.e. from one end of cross-member 130 coupled to the side member 115 to the other end of cross-member 130 coupled to the opposing side member 115). In some examples, the cross-members 130 may be substantially parallel to each other and may be substantially perpendicular to the frame members 120. The cross-members 130 may provide structural support to the frame members 120, and, more generally, provide structural support to the screen 100.

In some examples, the cross-members 130 may be structurally the same as the frame members 120 such that the cross-members have surface(s) angled downward relative to the mesh. In this manner, fluid passing through the screen 100 may contact the angled surface(s) of the cross-members 130 and may be deflected, diverted, and/or directed through the screen 100.

The frame members 120 and the cross-members 130 may form an intersecting pattern that may provide rigidity to the screen 100 and may support a mesh cloth of the screen 100. The voids formed between the frame members 120 and the cross-members 130 allow fluids or materials including solids to pass through the screen 100. This configuration may assist fluid including solids to more quickly pass through the screen 100, or at least not restrict the fluid from passing through the screen 100. In this manner, the screen 100 may have an increased fluid or material capacity. Without such orientation, fluid or material may be impeded or restricted from passing though the screen 100.

In some examples, the screen 100 and/or its components (e.g., end members 105, side members 115, frame members 120, cross-members 130) may be made of a composite material, such as a non-metallic material, for example, a composite material, composite polymer and/or plastic.

In some examples, the screen 100 may be manufactured as one piece or may be assembled from multiple pieces. The screen 100 (or pieces thereof) may be manufactured using known techniques, including, for example, injection molding. Some screen 100 may include the frame 110, the frame members 120, and the cross-members 130 all injection molded together as one unit. Some screens 100 may include the frame 110, the frame members 120, and the cross-members 130 being injection molded as separate units and fused together.

In some examples, the mesh may be fused to frame members 120 by melting a portion of the frame members 120 such that a portion of the frame member 120 flows through the mesh where the frame member 120 contacts the mesh. The frame members 120 may be cured through and/or around the mesh, effectively fusing the mesh to the frame members 120. In some examples, fusing may include applying a fusing source to (or at least near) a top surface of the frame members 120. Example fusing sources may include a heat source (e.g., hot plate) and/or vibration source (e.g., ultrasonic welder).

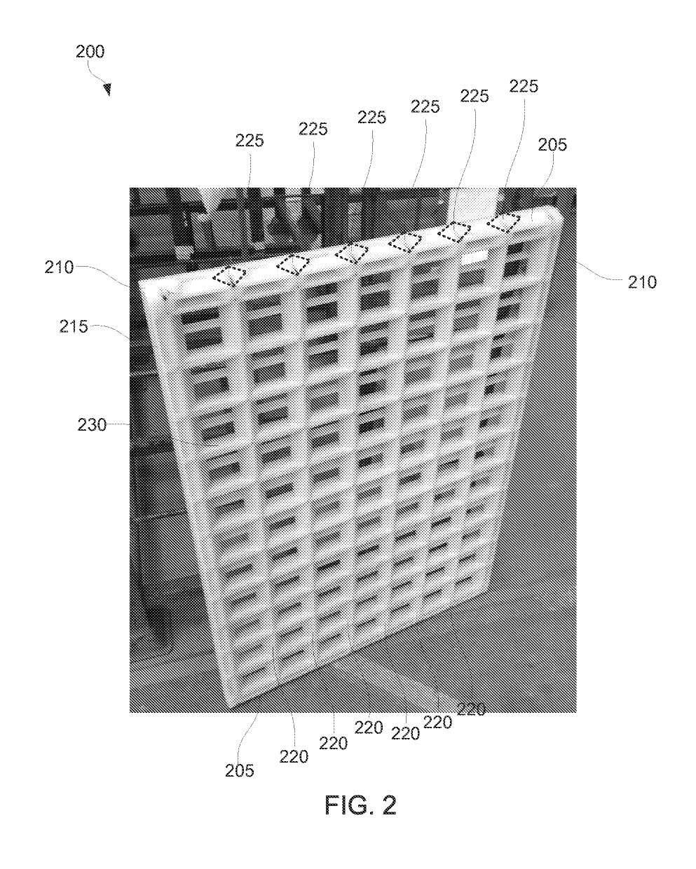

FIG. 2 depicts a perspective view of an example screen 200 having frame members 220 with angled surface(s), in accordance with at least one embodiment of the present disclosure. Similar to screen 100, screen 200 may include frame 210, frame members 220, and cross-members 230. The frame members 220 may be coupled to and extend between opposing end members 205 of the frame 210, and cross-members 230 may be coupled to and extend between opposing side members 215 of the frame 210. The frame members 220 and cross-members 230 are substantially perpendicular to each other. FIG. 2 shows an example quadrilateral shape cross section 225 of the frame members 220. The dotted lines depict the quadrilateral shape cross sections 225 of each frame member 220. The quadrilateral shape cross sections 225 indicate that surfaces of the frame members 220 are angled away (i.e. downward) from the top surface of the frame.

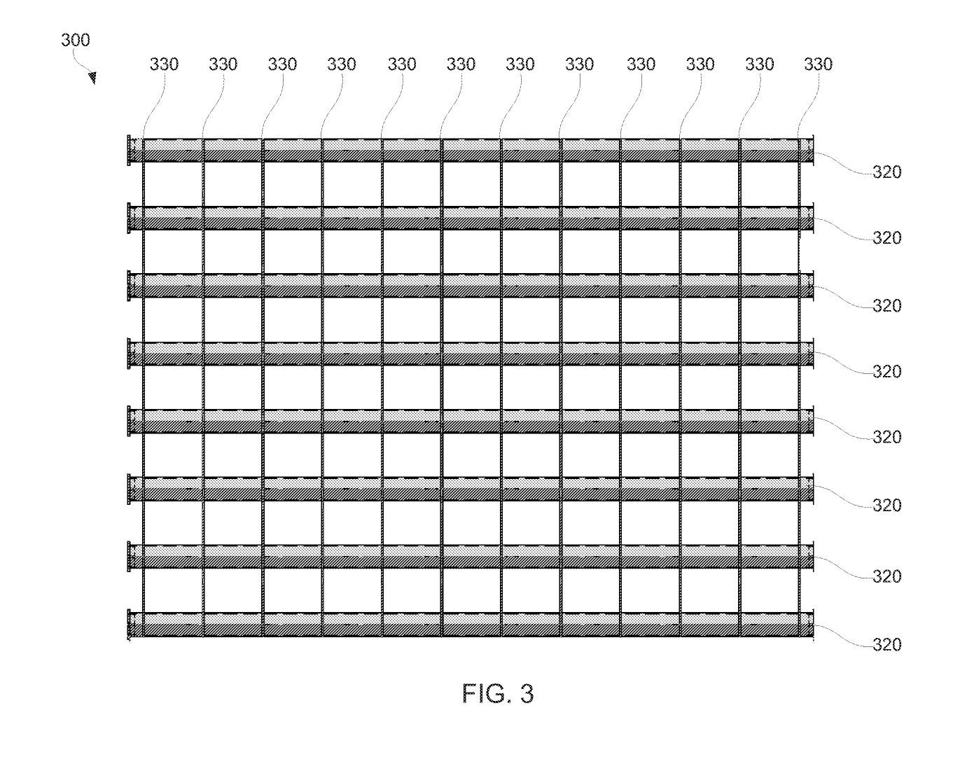

FIG. 3 depicts a plan view of yet another example screen 300 having frame members 320 with angled surface(s), in accordance with at least one embodiment of the present disclosure. FIG. 3 depicts a frameless example in accordance with the present disclosure. Similar to screens 100, 200, screen 300 may include frame members 320 and cross-members 330 oriented in a perpendicular manner. The frame members 320 are equidistant relative to each other. The cross-members 330 are equidistant relative to each other. The voids formed between the frame members 320 and the cross-members 330 may allow material to pass through. As shown in the top down view of FIG. 3, the surfaces of the frame members 320 appear to diverge.

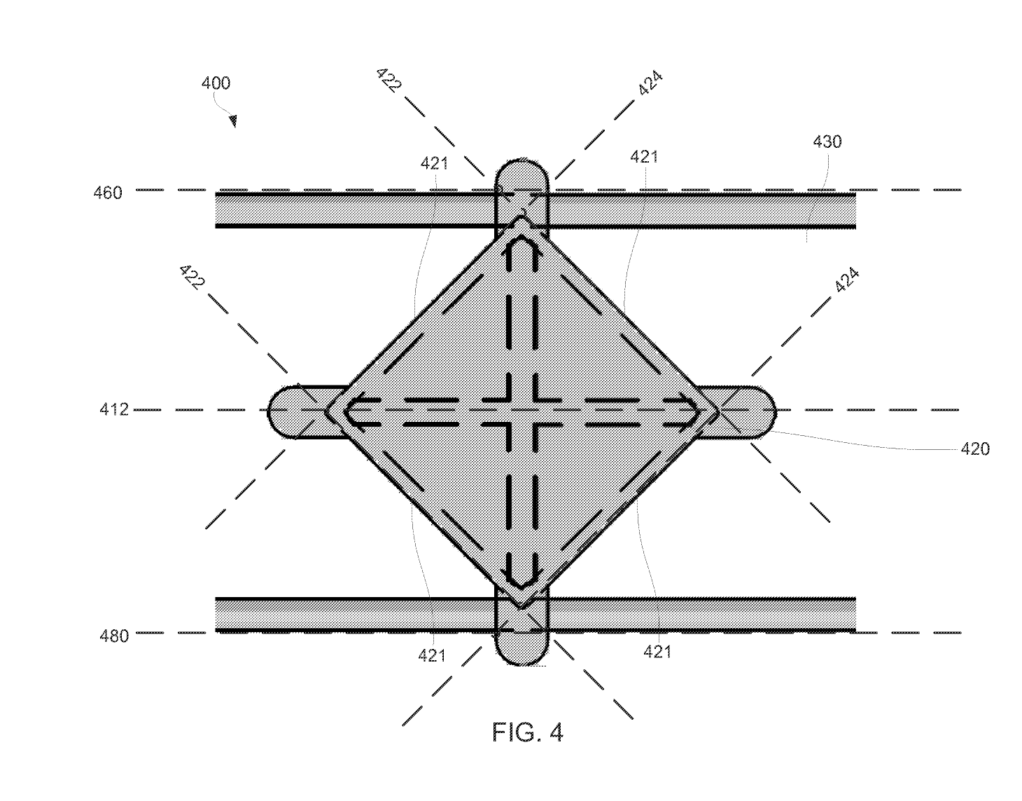

FIG. 4 depicts a partial side cross-sectional view of another example screen with frame members 420 having angled surfaces, in accordance with at least one embodiment of the present disclosure. FIG. 4 depicts an example orientation in which the frame member 420 is angled about an axis through the length of the frame member 420. The frame member 420 is angled relative to a plane 412 of the frame and the mesh 460.

The frame member 420 may include four surfaces 421 and may be a square frame member (Le., sides 421 are 90 degrees apart, the same width, and opposing sides are parallel to each other), but the present disclosure contemplates that other shaped frame members may also be implemented in other examples. The frame member's 420 surfaces 421 each exist in a plane 422, 423. The planes 422, 423 are not coplanar with the plane 412 of the frame or a bottom surface plane 480 of the frame, and the planes 422, 423 are not coplanar with the mesh 460. The frame member 420 extends above or beyond the mesh 460. The frame member 420 may be coupled to the mesh 460. The frame member 420 also extends below or beyond the bottom surface plane 480 of the frame.

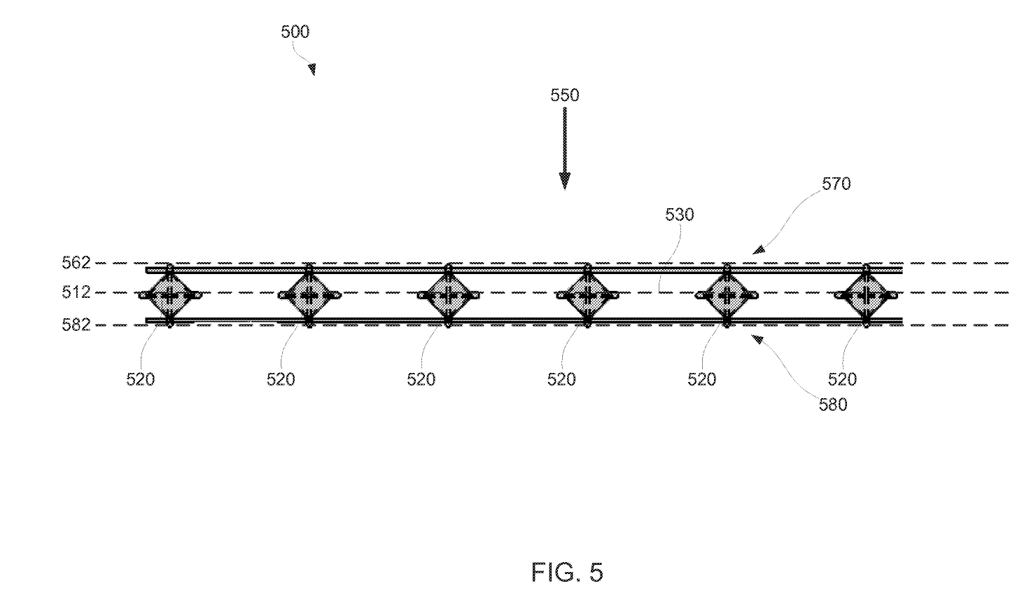

FIG. 5 depicts a side cross-sectional view of another example screen 500 having frame members 520 with angled surface(s), in accordance with at least one embodiment of the present disclosure. The screen 500 may include a frame, frame members 520, cross-members 530, and mesh 562. The frame members 520 and cross-members 530 may be oriented in a perpendicular manner relative to each other. The plane 512 of the frame may be substantially horizontal (e.g., parallel to the Earth's surface). The frame may have a bottom planar surface 582.

The screen 500 may include an inlet 570 and an outlet 580. Fluid (or material) including solids may flow in the direction of arrow 550, and may enter screen via inlet 570. The fluid may pass through the mesh 562. The screened fluid (e.g., fluid including only solids not stopped by mesh 562) may be outlet via outlet 580 (passing through the bottom planar surface 582).

The frame members 520 may have surfaces angled at approximately 45 degrees relative to the mesh 562 and planes 512, 582. In this manner, the frame members 520 may be configured such that their cross-sections are substantially angled or tilted relative to the mesh 562 and planes 512, 582. When fluid contacts the downward angled surfaces of the frame members 520, the fluid may be diverted or directed downward through the screen 500. The angle of frame members 520 may assist fluid including solids to more quickly pass through screen 500 because the frame members may block less mesh area than conventional screens. Further, the angled surfaces of the frame members 520 may provide less surface area (than conventional screens) on which material may be impeded or restricted.

FIGS. 6-9 depict example cross-sectional views of example screens having frame members with angled surface(s), in accordance with embodiments of the present disclosure.

FIG. 6 depicts a cross-section of frame member 620 having surfaces angled downward from mesh 662. The frame member 620 has a substantially square shape cross-section. The frame member 620 is angled such that its surfaces are angled relative to the mesh 662. Specifically, the angles between the surface of the frame member 620 and the mesh 662 are identified as α and β. In some examples, α and β may be equal. For example, α may equal about 45 degrees and β may equal about 45 degrees. In some examples, α and β may be different values. For example, α may equal about 30 degrees and β may equal about 60 degrees.

Fluid may flow downward onto and through the screen. Fluid may follow the path identified by arrows 690. After passing through mesh 662, the fluid may contact the downward angled surfaces of the frame member 620 and may be diverted or directed along (or in the general direction of) the surface. After contacting the surface of frame member 620, the fluid may follow the path identified by arrows 692.

A portion of the frame member 620 extends above and/or through the mesh 662. The portion of the frame member 620 above the mesh 662 may be coupled (e.g., fused) to the mesh 662 using the methods described herein.

FIG. 7 depicts a cross-section of frame member 720 having surfaces angled downward from mesh 762. The frame member 720 has a substantially square shape cross-section. The frame member 720 is angled such that its surfaces are angled relative to the mesh 762. Specifically, the angles between the surface of the frame member 720 and the mesh 762 are identified as α and β. In some examples, α and β may have very different values. For example, α may equal about 80 degrees and β may equal about 10 degrees.

Fluid may flow downward onto and through the screen. Fluid may follow the path identified by arrows 790. After passing through mesh 762, the fluid may contact the downward angled surfaces of the frame member 720 and may be diverted or directed along (or in the general direction of) the surface. After contacting the surface of frame member 720, the fluid may follow the path identified by arrows 792.

A portion of the frame member 720 extends above and/or through the mesh 762. The portion of the frame member 720 above the mesh 762 may be coupled (e.g., fused) to the mesh 762 using the methods described herein.

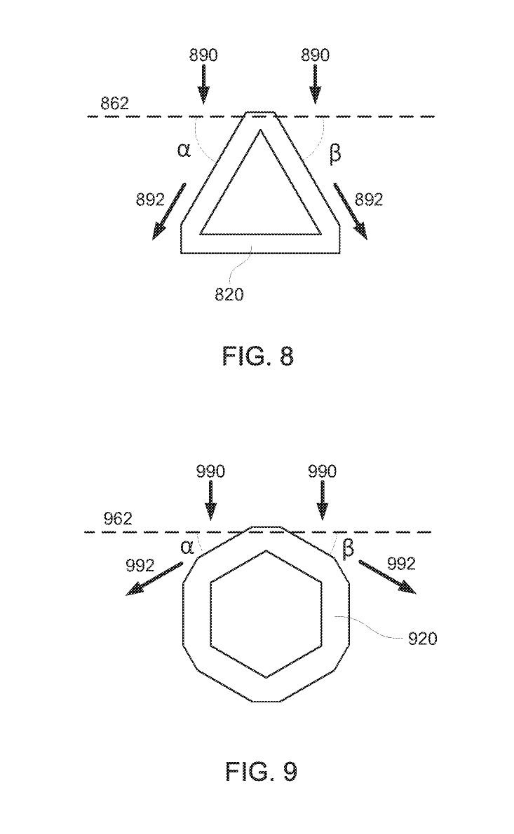

FIG. 8 depicts a cross-section of frame member 820 having surfaces angled downward from mesh 862. The frame member 820 has a substantially triangular shape cross-section, The frame member 820 is angled such that its surfaces are angled relative to the mesh 862. Specifically, the angles between the surface of the frame member 820 and the mesh 862 are identified as α and β. In some examples, α and β may the same or similar values. For example, α may equal about 60 degrees and β may equal about 60 degrees. In some examples, α and β may be different values. For example, α may equal about 20 degrees and β may equal about 70 degrees.

Fluid may flow downward onto and through the screen. Fluid may follow the path identified by arrows 890. After passing through mesh 862, the fluid may contact the downward angled surfaces of the frame member 820 and may be diverted or directed along (or in the general direction of) the surface. After contacting the surface of frame member 820, the fluid may follow the path identified by arrows 892.

A portion of the frame member 820 extends above and/or through the mesh 862. The portion of the frame member 820 above the mesh 862 may be coupled (e.g., fused) to the mesh 862 using the methods described herein.

FIG. 9 depicts a cross-section of frame member 920 having surfaces angled downward from mesh 962. The frame member 920 has a substantially hexagonal shape cross-section. The frame member 920 is angled such that its surfaces are angled relative to the mesh 962. Specifically, the angles between the surface of the frame member 920 and the mesh 962 are identified as α and β. In some examples, α and β0 may the same or similar values. For example, α may equal about 15 degrees and β may equal about 15 degrees. In some examples, α and β may be different values. For example, α may equal about 30 degrees and β may equal about 60 degrees.

Fluid may flow downward onto and through the screen. Fluid may follow the path identified by arrows 990. After passing through mesh 962, the fluid may contact the downward angled surfaces of the frame member 920 and may be diverted or directed along (or in the general direction of) the surface. After contacting the surface of frame member 920, the fluid may follow the path identified by arrows 992.

A portion of the frame member 920 extends above and/or through the mesh 962. The portion of the frame member 920 above the mesh 962 may be coupled (e.g., fused) to the mesh 962 using the methods described herein.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. An apparatus, comprising:
a frame having opposing ends, opposing sides, and a plurality of frame members, each of the plurality of frame members being coupled to and extending between the opposing ends; and
a mesh coupled to the plurality of frame members such that at least a portion of the plurality of frame members extends through the mesh;
wherein the plurality of frame members have at least one surface angled downward relative to the mesh.

2. The apparatus of claim 1, wherein the at least one surface of the plurality of frame members is angled downward from mesh in the range of about 10 degrees to about 80 degrees.

3. The apparatus of claim 1, wherein a cross section of each of the plurality of frame members comprises at least one of a triangle shape, a parallelogram shape, a square shape, a rhombus shape, a pentagon shape, a hexagon shape, and an octagon shape.

4. The apparatus of claim 1,
wherein a cross section of each of the plurality of frame members is a square shape; and
wherein the at least one surface of the plurality of frame members is angled downward from the mesh at about 45 degrees.

5. The apparatus of claim 1, wherein the at least one surface of the frame member is not coplanar with mesh.

6. The apparatus of claim 1, further comprising:
a plurality of cross-members, each of the plurality of cross-members being coupled to arid extending between the opposing sides, wherein the plurality of cross-members have at least one surface angled downward relative to the mesh.

7. A method, comprising:
positioning a screen to filter fluid, the screen having a mesh and a frame, the frame having opposing ends, opposing sides, and a plurality of frame members, each of the plurality of frame members being coupled to and extending between the opposing ends;
causing fluid to pass through the screen such that the fluid contacts at least one surface of the plurality of frame members, the at least one surface being angled downward relative to the mesh.

8. The method of claim 7, wherein positioning the screen to filter fluid comprises positioning the screen in a shaker.

9. The method of claim 7, wherein the fluid is directed downward through the screen by the at least one surface of the plurality of frame members.

10. The method of claim 7, wherein the fluid diverges upon contact with the at least one surface of the plurality of frame members.

11. The method of claim 7, wherein the at least one surface of the plurality of frame members is angled downward from the mesh in the range of about 10 degrees to about 80 degrees.
